(19) United States
(12) Patent Application Publication
(10) Pub. No.: US 2020/0052553 A1
(43) Pub. Date: Feb. 13, 2020

(54) DEVICE FOR CONVERTING MECHANICAL ENERGY INTO ELECTRIC POWER

(71) Applicant: Romano FRANCESCHELLI, Sasso Marconi (IT)

(72) Inventor: Romano FRANCESCHELLI, Sasso Marconi (IT)

(21) Appl. No.: 16/335,888

(22) PCT Filed: Sep. 22, 2017
(86) PCT No.: PCT/EP2017/074029

§ 371 Date: Mar. 22, 2019

(30) Foreign Application Priority Data
Sep. 28, 2016 (IT) 102016000097042

(51) Int. Cl. H02K 7/18; H02K 7/02; F03G 3/00

(52) U.S. Cl. CPC H02K 7/1853; H02K 2201/18; F03G 3/00; H02K 7/02

(57) ABSTRACT

A device for converting mechanical energy into electric power, which includes at least one supporting frame for a supporting assembly that can slide according to a predefined stroke. The assembly is preset for rotatably accommodating at least one shaft; the shaft and the assembly are able to oscillate with respect to the frame. The upper end of the shaft, which protrudes upward from the supporting assembly, including a radial protruding arm provided with a terminal inertial element; the shaft is associated with a unit for converting mechanical energy into electric power. A source of mechanical energy is designed for the alternating movement of the assembly on the frame.

### TECHNICAL FIELD

The present disclosure relates to a device for converting mechanical energy into electric power with high conversion efficiency.

This device is ideal also for the conversion of electric power that originates from a predefined power source into mechanical energy, with subsequent conversion of said mechanical energy into electric power; the high efficiency of the device makes it profitable to perform the mentioned energy conversions.

### BACKGROUND

All electrical machines have rather low energy conversion efficiency values, in relation to the high fraction of energy that is dispersed due to frictions, losses and the like.

Among electrical machines, the only ones that have high efficiency values are static ones, in particular current transformers.

Among dynamic machines (i.e., all conventional generators that operate with direct current or alternating current), the energy conversion efficiency is rather low.

### SUMMARY

The aim of the present disclosure is to solve the problems described above, proposing a device for converting mechanical energy into electric power that has a higher conversion efficiency than the typical efficiency of conventional electrical machines.

Within the scope of this aim, the disclosure proposes a device for converting mechanical energy into electric power that minimizes the energy consumption caused by friction and losses.

The present disclosure also provides a device for converting mechanical energy into electric power that has modest costs, is relatively simple to provide in practice and is safe in application.

This aim and these and other advantages which will become better apparent hereinafter are achieved by providing a device for converting mechanical energy into electric power, characterized in that it comprises at least one supporting frame for a supporting assembly that can slide according to a predefined stroke, said assembly being preset for rotatably accommodating at least one shaft, said shaft and said assembly being able to oscillate with respect to said frame, the upper end of said shaft, which protrudes upward from said supporting assembly, comprising a radial protruding arm provided with a terminal inertial element, said shaft being associated with a unit for converting mechanical energy into electric power, a source of mechanical energy being designed for the alternating movement of said assembly on said frame, the rotation of said shaft, synchronously with the alternating motion of said assembly, being determined substantially, for at least one descending portion of the trajectory of said arm, by the force of gravity that acts on said inertial element and being substantially determined, at least for an ascending portion, by the inertial dragging of said inertial element.

### BRIEF DESCRIPTION OF THE DRAWINGS

Further characteristics and advantages of the disclosure will become better apparent from the description of a preferred but not exclusive embodiment of the device for converting mechanical energy into electric power according to the disclosure, illustrated by way of nonlimiting example in the accompanying drawings, wherein:

FIG. 1 is a schematic axonometric view of a device for converting mechanical energy into electric power according to the disclosure; and

FIG. 2 is a schematic side view of the device of FIG. 1.

### DETAILED DESCRIPTION OF THE DRAWINGS

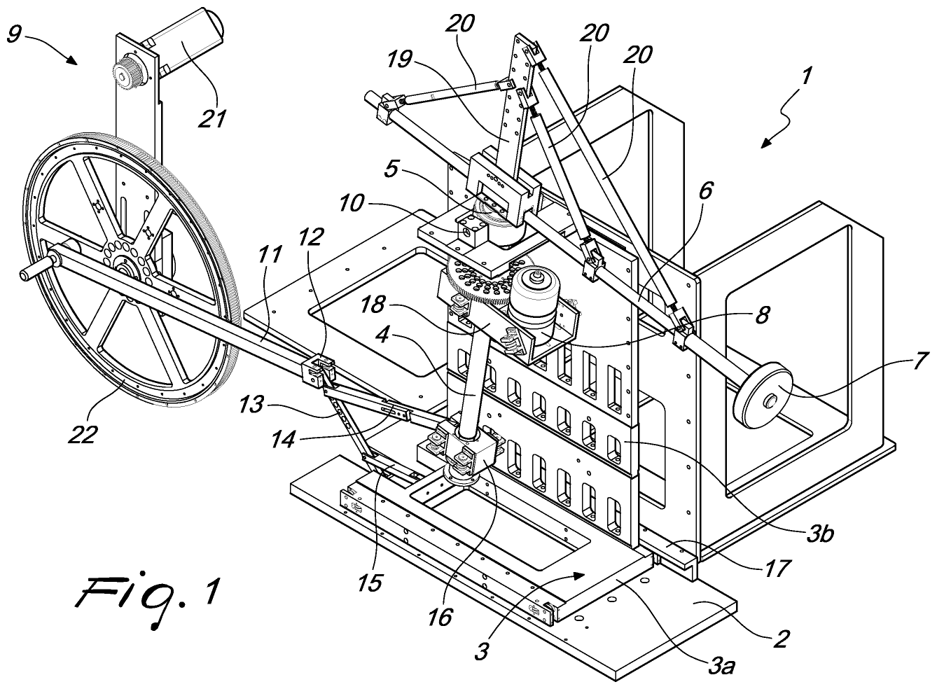

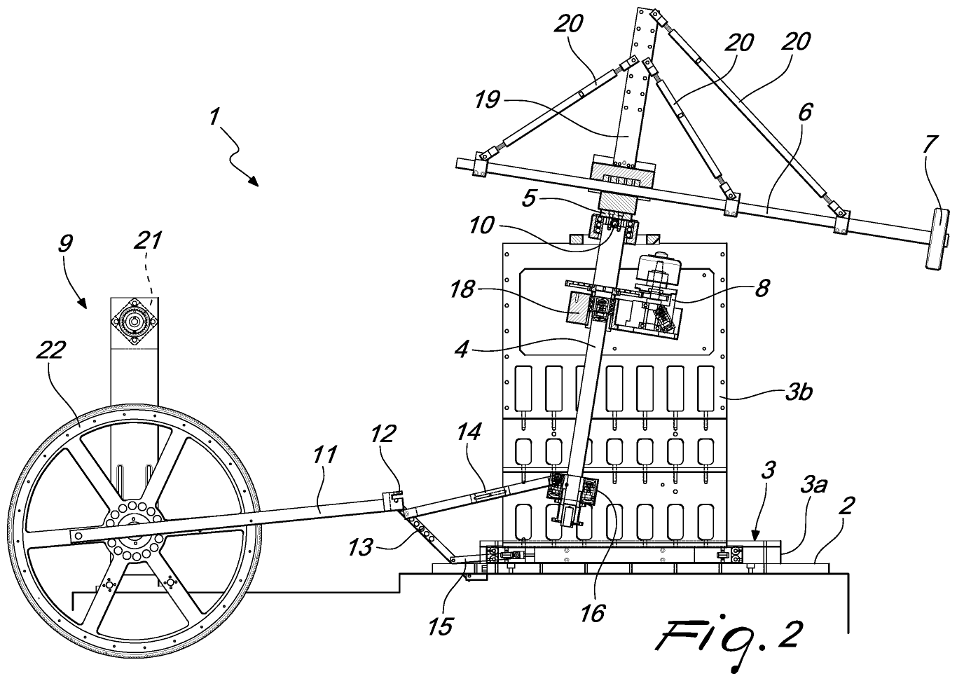

With particular reference to FIGS. 1 and 2, the numeral 1 designates generally a device for converting mechanical energy into electric power.

The device 1 comprises at least one supporting frame 2 for a supporting assembly 3 that can slide according to a predefined stroke.

In order to ensure the necessary stability to the device 1, the frame 2 is preferably constituted by a metallic structure that has a very wide base. It is possible to fix the frame 2 to the ground in order to avoid possible movements and vibrations triggered by the movable elements that are present. The same result can be achieved by providing a frame 2 that has a large mass.

The supporting assembly 3 is designed to accommodate rotatably at least one shaft 4.

The fact that the shaft 4 and the assembly 3 can oscillate with respect to the frame 2 is important for the purposes of the operation of the device 1.

The upper end 5 of the shaft 4, which protrudes upward from the supporting assembly 3, comprises a protruding arm 6, which is arranged in a radial direction and is provided with a terminal inertial element 7 (which allows to utilize inertia and the effects of centrifugal force).

It is specified that the shaft 4 is associated with a unit 8 for converting mechanical energy into electric power; the association can be direct (by means of gears, belts, chains and similar devices) or speed reduction/multiplier units can be interposed.

The alternating movement, according to the already cited predefined stroke that will be performed in repeated back-and-forth sequences, of the assembly 3 on the frame 2 is obtained by virtue of the presence of a mechanical energy source 9.

The rotation of the shaft 4, synchronously with the alternating motion of the supporting assembly 3, is instead substantially determined for at least one descending portion of the path of the arm 6 by the force of gravity that acts on the inertial element 7; this rotation is instead substantially determined, at least for an ascending portion of the path of the arm 6, by the inertial dragging of the inertial element 7.

In this manner it is possible to ensure that the unit 8 for conversion of mechanical energy (rotational energy of the shaft 4) into electric power operates in maximum efficiency conditions, since the mechanical energy source 9 is assigned solely to providing the reciprocating motion of the supporting assembly 3, minimizing energy losses and implementing overall efficiency in the best possible way.

According to the disclosure, it is specified that the shaft 4 is coupled to the assembly 3 with two degrees of freedom: a first degree of freedom has the purpose of allowing the rotation of the shaft 4 about its own axis, while a second degree of freedom allows the oscillation of the shaft 4 with respect to a transverse pivoting axis 10.

With particular reference to a constructive solution of unquestionable practical interest, the mechanical energy source 9 can conveniently comprise at least one linkage 11 provided with a reciprocating motion.

Said linkage 11 is pivoted at one of its heads 12 to a first lever 13 and to a second lever 14.

The terminal end of the first lever 11 is in turn pivoted to the frame 2 and a substantially central portion thereof is pivoted to a rod 15 which in turn is pivoted to the assembly 3.

The terminal end of the second lever 14 is instead pivoted on a guiding carriage 16 for the shaft 4.

The carriage 16 has the purpose of guiding the oscillations of the shaft 4 so that it does not undergo axial displacements: rolling elements (such as rolling bearings, wheels, rollers and the like) are provided in order to minimize energy losses due to the sliding of the carriage 16 in the respective receptacle.

The frame 2 comprises respective guiding tracks 17 for the supporting assembly 3.

The supporting assembly 3 in turn is constituted by a lower slider 3a from which two mutually opposite, parallel and substantially vertical walls 3b extend.

With particular reference to a possible application of the present disclosure that is particularly efficient, the unit 8 for converting mechanical energy into electric power is accommodated on a sliding element 18 which is integral with a portion of the shaft 4.

The sliding element 18 also has the purpose of guiding the oscillations of the shaft 4 (in addition to supporting the unit 8) so that it does not undergo axial displacements: rolling elements (such as rolling bearings, wheels, rollers and the like) are provided in order to minimize the energy losses due to the siding of the carriage 16 in the respective receptacle.

It is important to point out that the guiding carriage 16 and the sliding element 18 can move, according to a stroke that is defined by the oscillation of the shaft 4 with respect to the axis 10, between the mutually opposite walls 3b of the supporting assembly 3.

It is specified that in a particularly efficient and simple to implement version, the predefined stroke of the supporting assembly 3 is comprised between 15% and 30% of the length of the lower slider 3a of said assembly 3.

In this manner, the maximum displacement of the assembly 3 (with respect to a central position of the stroke) is in any case less than 15% of the length of its lower slider 3a, thus ensuring the maximum stability of the assembly 3 itself.

Within the scope of applicative versions of the present disclosure that allow optimum operation and high conversion efficiencies, the shaft 4 preferably can have a total length that is variable between 15% less and 30% more than the length of the lower slider of the assembly 3.

In this case also, the introduced dimensional parameters have the purpose of defining the right proportions among the various components in order to minimize energy losses and the mechanical stresses to which the various components are subjected.

An excessively long shaft 4, which therefore protrudes greatly with respect to the assembly 3, would in fact be subjected easily to a high flexing load during the operation of the device 1 and therefore would require generous sizing (large diameter).

Vice versa, an excessively short shaft 4, despite being less stressed mechanically during operation, would entail the adoption of a very long second lever 14 (which in turn would be subjected to an excessive mechanical load, which would require an oversizing thereof).

Furthermore, it is deemed useful to specify that above the upper end 5 of the shaft 4 and above the arm 6 there is a strut 19 and there are respective tension members 20 for stiffening and stabilizing said arm 6.

The arm 6, following a trajectory that provides for ascending and descending portions, would undergo mechanical stresses of the flexural type on the part of the inertial element 7: the presence of the strut 19 and of the tension members 20 minimizes the effects of these stresses on the shaft 6, thus ensuring that it does not flex inward during the operation of the device 1.

Finally, it is stressed that the mechanical energy source 9 is a motor 21 which is associated with a crank 22 to which the linkage 11 is pivoted.

The motor 21 can be of the type preferably chosen among an electric motor, a fluid-driven motor, a turbine, an internal combustion engine, and the like.

It has thus been shown that the device 1 can convert an intermittent mechanical impulse (generated by a respective source) into electric power with a high conversion efficiency (since the effects of friction and of aerodynamic drag are compensated by inertial dragging and by the effect of the force of gravity on the element 7 arranged at the end of the arm 6).

Advantageously, the present disclosure solves the problems described earlier, proposing a device 1 for converting mechanical energy into electric power that has a higher conversion efficiency than the typical one of conventional electrical machines.

Efficiently, the device 1 according to the disclosure minimizes the energy consumption caused by frictions and losses.

Validly, the present disclosure allows to provide a device 1 for converting mechanical energy into electric power that has modest costs and is relatively simple to provide in practice: these advantages make the device 1 according to the disclosure an innovation of assured and convenient application.

The disclosure thus conceived is susceptible of numerous modifications and variations, all of which are within the scope of the appended claims; all the details may furthermore be replaced with other technically equivalent elements.

For example, if the motor 21 is electric, it can be selected of the brushless type, which in turn can be associated effectively with a control processor (not shown in the figures) for the optimization of energy consumption and the consequent conversion of mechanical energy into electric power with high efficiency.

The motor 21 can be associated with a reduction unit in order to establish a mechanical oscillation with the ideal period (which is understood as the duration interval of a complete back and forth motion of the assembly 3).

Merely by way of example, the arm 6 (and the shaft 4) easily reach rotation rates of more than 100 rpm, even if the inertial element 7 has a considerable mass (greater than 10 kg, up to even several tens of kilograms).

In particular, the body 7 arranged at the end of the arm 6 follows the descending portion of its trajectory (from the maximum height from the ground to the minimum height) by virtue of the effect of gravitational attraction, which draws it toward the ground, and when it reaches the minimum height from the ground it is drawn upward (in the ascending part of its trajectory) by the inertial element 7 that gained speed previously (also by virtue of the oscillating motion of the shaft 4 ensured by the mechanical energy source 9).

In the examples of embodiment shown, individual characteristics, given in relation to specific examples, may actually be interchanged with other different characteristics that exist in other examples of embodiment.

In practice, the materials used, as well as the dimensions, may be any according to the requirements and the state of the art.

The disclosures in Italian Patent Application No. 102016000097042 (UA2016A006887) from which this application claims priority are incorporated herein by reference.

1-10. (canceled)

11. A device for converting mechanical energy into electric power, comprising at least one supporting frame for a supporting assembly that can slide according to a predefined stroke, said assembly being preset for rotatably accommodating at least one shaft, said shaft and said assembly being able to oscillate with respect to said frame, the upper end of said shaft, which protrudes upward from said supporting assembly, comprising a radial protruding arm provided with a terminal inertial element, said shaft being associated with a unit for converting mechanical energy into electric power, a source of mechanical energy being designed for an alternating movement of said assembly on said frame, a rotation of said shaft, synchronously with the alternating motion of said assembly, being determined substantially, for at least one descending portion of the trajectory of said arm, by the force of gravity that acts on said inertial element and being substantially determined, at least for an ascending portion, by the inertial dragging of said inertial element.

12. The device according to claim 11, wherein said shaft is coupled to said assembly with two degrees of freedom, a first degree of freedom to allow the rotation of said shaft about a shaft axis and a second degree of freedom for the oscillation of said shaft with respect to a transverse pivoting axis.

13. The device according to claim 12, wherein said source of mechanical energy comprises at least one linkage provided with a reciprocating motion, said linkage being pivoted at one of a linkage head to a first lever and to a second lever, a terminal end of said first lever being pivoted to said frame and a substantially central portion thereof being pivoted to a rod, which in turn is pivoted on said assembly, a terminal end of said second lever being pivoted on a guiding carriage for said shaft.

14. The device according to claim 11, wherein said frame comprises respective guiding tracks for said supporting assembly, said supporting assembly comprising a lower slider from which two mutually opposite, parallel and substantially vertical walls extend.

15. The device according to claim 13, wherein said unit for conversion of mechanical energy into electric power is accommodated on a sliding element that is integral with a portion of said shaft.

16. The device according to claim 15, wherein said guiding carriage and said sliding element can move, according to a stroke defined by the oscillation of the shaft with respect to the axis, between said mutually opposite walls of said supporting assembly.

17. The device according to claim 14, wherein the predefined stroke of said supporting assembly is comprised between 15% and 30% of a length of said lower slider of said assembly.

18. The device according to claim 17, wherein said shaft has an overall length that can vary between 15% less and 30% more than the length of said lower slider of the assembly.

19. The device according to claim 11, wherein above the upper end of said shaft and of said arm there are a strut and respective tension members for the stiffening and stabilization of said arm.

20. The device according to claim 13, wherein said source of mechanical energy is a motor associated with a crank to which the linkage is pivoted, said motor being chosen among an electric motor, a fluid-driven motor, a turbine, and an internal combustion engine.
